(19) United States
(12) Patent Application Publication
(10) Pub. No.: US 2006/0190754 A1
(43) Pub. Date: Aug. 24, 2006

(54) A Method for Automatic Recognition of Handshake Data Exchange at Clock-Domain Crossing in Integrated Circuit Design

(75) Inventors: Alain Dargelas, San Jose, CA (US); Paras Mal Jain, San Jose, CA (US); Ashish Hari, San Jose, CA (US); Bernard Murphy, San Jose, CA (US); Anthony Joseph, San Jose, CA (US)

Correspondence Address: SUGHRUE MION, PLLC, 2100 PENNSYLVANIA AVENUE, N.W., SUITE 800, WASHINGTON, DC, 20037, US

(73) Assignee: ATRENTA, INC., San Jose, CA (US)

(21) Appl. No.: 10/906,571

(22) Filed: Feb. 24, 2005

(51) Int. Cl. G06F 3/00

(52) U.S. Cl. 713/400

(57) ABSTRACT

A structural analysis tool automatically detects complex handshake mechanisms for controlling data transfers between clock-domain crossings. The structural analysis tool may also verify the correctness of the handshake mechanism.

### BACKGROUND

The present invention relates generally to clock synchronization validation in integrated circuit (IC) design, and more particularly to a method for recognizing handshake data exchange in IC design.

In recent years the size of integrated circuits (ICs) has dramatically increased in both size and number of logical components. This has resulted in multiple clocks activating the logical components. In typical IC designs, a clock domain is defined as a set of memory components, e.g., flip-flops, registers, synchronous RAM, and so on, that are clocked on the same edge of the same clock net. Clock domains may exchange data. A point where clock domains exchange data may be referred to as a “clock-domain crossing.” Clock domains that exchange data need to be interfaced and synchronized in reliable and predictable ways to ensure the proper transfer of data from one clock domain to another.

Signals between a first logic circuit in a first clock domain and a second logic circuit in a second clock domain are transferred asynchronously. Such asynchronous transfers, however, require some control to avoid undesirable results. For example, such an undesirable result might occur if a data signal were transferred from a first logic circuit at the same time a clock signal for a second logic circuit triggered a register that receives as input the data signal. To prevent this, the transfer of signals between clock crossing domains may be controlled by means of a handshake process.

Referring to FIG. 1, an illustration of a logic circuit 100 used to implement a conventional handshake process of asynchronous transfer between logic circuits is shown. Circuit 100 includes two sequential logic circuits 110 and 120, each of which is triggered by a different clock. Logic circuit 110 in a source clock domain comprises a source register 112 and a source finite state machine (FSM) 113. Logic circuit 120 in the destination clock domain includes a destination register 122 and a destination FSM 123. In this example, data is transferred from source register 112 to destination register 122. Source FSM 113 and destination FSM 123 control the sequence of operations enabling the synchronization of handshake signals, including READY 130, request (REQ) 140, acknowledge (ACK) 150, and LOAD 160. This way, FSMs 113 and 123 together allow to asynchronously transfer data from source register 112 to destination register 122. Specifically, READY signal 130 is asserted by source FSM 113 to inform source register 112 that the data in its input is ready to be loaded. Destination register 122 is not aware that source register 112 has data available for transfer. Therefore, a control signal, REQ 140, sent by source FSM 113, informs FSM 123 that source register 113 has data available and is ready to transmit it. Destination FSM 123, upon receiving REQ signal 140, sends LOAD signal 160 to destination register 122, informing that data is available. ACK signal 150 is asserted by destination FSM 123 to inform source FSM 112 that destination register 122 has received the data from source register 112. Source FSM 122 ensures that the content of source register 112 does not change after REQ signal 140 is asserted, until it detects the assertion of ACK signal 150. Namely, a new READY signal is generated only upon receiving of the ACK signal.

The prior art handshake techniques just mentioned are further exemplified by the following U.S. patents, each of which is incorporated herein by reference for its useful background description of the state of the art heretofore. In U.S. Pat. No. 6,006,340, O'Connell discloses a method and system to create communications interface, i.e., handshake mechanism, between two finite state machines operating in different clock domains. Gandhi, in U.S. Pat. No. 6,172,540, describes a circuit to transfer data from a first clock domain to a second clock domain asynchronous with respect to the first clock domain. Lo, etal., in U.S. Pat. No. 6,247,082, teaches a method and circuit for handshaking information across multiple clock domains within an electronic system. U.S. Pat. Nos. 6,327,207 and 6,366,530 by Sluiter, et al. provide a method for synchronizing data operations across a synchronization boundary between different clock domains using two-hot encoding.

In the design of a typical IC the handshake process is intensively used for synchronizing data transfer between clock-domains. This process is implemented using complex structures that are usually not recognized by clock-domain analysis tools. Generally, clock-domain analysis tools are used to check for verification of clock domains early in the design process. The verification is performed by identifying synchronization cells in the design. Simple synchronization cells, such as a double-level register and a recirculation MUX, can be easily verified by exploring the structure of the IC's design. This verifying process is usually referred to as “structural analysis”. However, complex structures, such as handshake mechanisms, cannot be verified using structural analysis and thus cannot be verified by prior art analysis tools. As a result, such tools generally identify all asynchronous clock-domains, that are not structurally verifiable, as invalid asynchronous clock domains, even if those clock domains are well-synchronized. Consequently, this requires a designer to spend significant time in verifying each asynchronous clock domain separately. In typical ICs, where the number of clock-domain crossings may be large, this is an inefficient and a time-consuming task as well as being error prone.

The prior art analysis tools just mentioned are exemplified by the following U.S. patents, each of which is incorporated herein by reference for its useful background description of the state of the art heretofore. In U.S. Pat. No. 6,353,906 by Smith, et al., a method for testing an asynchronous digital design in which a non-synchronized signal crosses from a first clock domain to a second clock domain is described. U.S. Pat. No. 6,099,579 “Method and apparatus for checking asynchronous HDL circuit designs” provides a design tool that performs an exhaustive search of all circuits and identifies any asynchronous behavior. Nevertheless, the solutions described in the inventions U.S. Pat. Nos. 6,353,906 and 6,099,579 are not being capable of recognizing handshake mechanisms in the clock-domain crossing.

### SUMMARY OF THE INVENTION

In view of the limitations of the prior art, it would be advantageous to provide a method for recognizing handshake mechanisms in clock-domain crossings of IC designs. It would be further advantageous to provide a method for correctness verification of handshake mechanisms detected in an IC design.

According to the invention, there is thus provided a method and also a computer program product for the automatic recognition and/or verification of handshake data exchange at clock-domain crossing in integrated circuit design.

The invention is taught below by way of various specific exemplary embodiments explained in detail, and illustrated in the enclosed drawing figures.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 is an illustration of a logic circuit used to implement a conventional handshake mechanism in a clock-domain crossing (prior art);

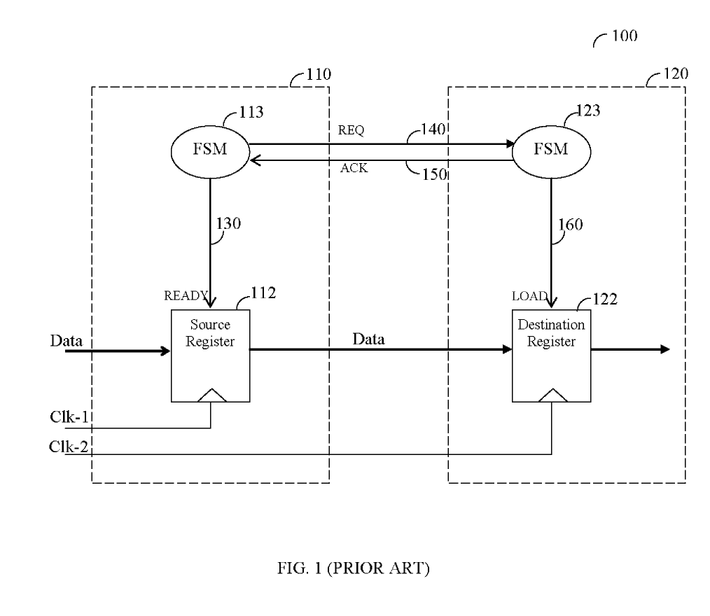

FIG. 2 is an exemplary logic circuit to be verified by one method according to the present invention;

FIG. 3 is a non-limiting flowchart describing the method for recognition of a handshake process at clock-domain crossings in an IC design;

FIG. 4 is a non-limiting flowchart describing a procedure for detecting REQ signals

FIG. 5 is a non-limiting flowchart describing a procedure for detecting ACK signals; and

FIG. 6 is an exemplary RTL description of a module implementing a handshake process to be verified by a method according to the present invention.

### DETAILED DESCRIPTION OF THE INVENTION

The invention will now be taught using various exemplary embodiments. Although described in detail, it will be appreciated that the invention is not limited to just the described embodiments, but has a scope that is significantly broader. The appended claims should be consulted to determine the true scope of the invention.

Disclosed is a method for recognizing handshake mechanisms by performing structural analysis of the IC design. Data transfers between clock-domain crossings in designs of ICs are handled by handshake mechanisms. These mechanisms are complex structures that are not readily recognized by clock-domain analysis tools known in the art. As a result, analysis tools report the clock-domain crossings as desynchronized, when in fact they are synchronized correctly.

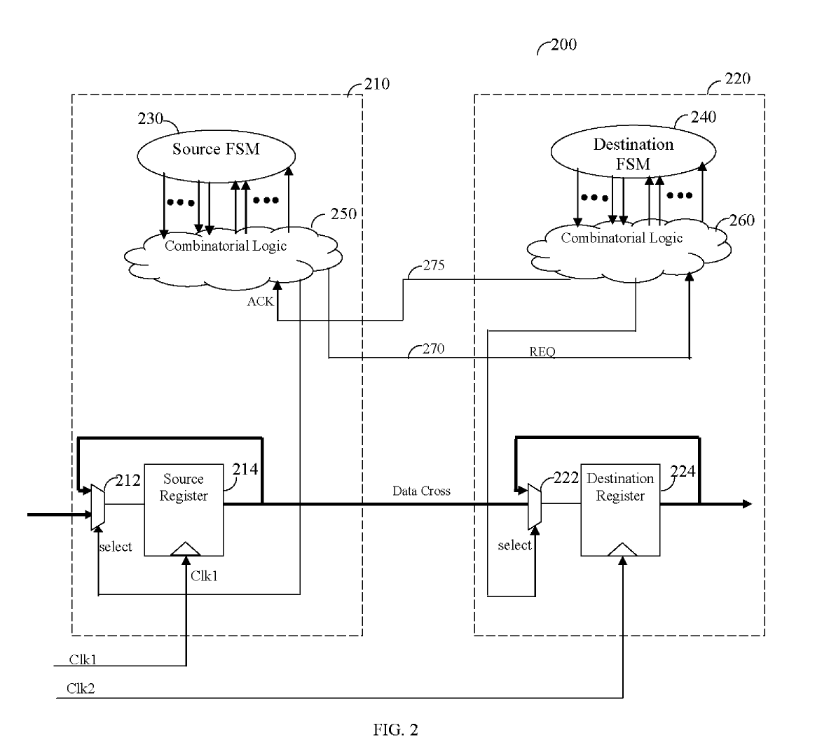

Referring to FIG. 2, an exemplary logic circuit 200 to be verified by a method according to the present invention is shown. Circuit 200 includes a first clock domain 210 and a second clock domain 220. Clock domain 210 sends data to clock domain 220 through a data bus “Data Cross”. The first clock domain 210 includes a recirculation MUX 212 and a register 214 clocked by clock signal “Clk1”. The second clock domain 220 includes a recirculation MUX 222 and a register 224 clocked by clock signal “Clk2”.

In other implementations the source and destination registers 214 and 224 may be gated using an AND logic gate. Each of registers 214 and 224 may be any data holding enabled logic component, such as a flip-flop, a memory cell, a combinational logic loop that form a de-facto memory, and the like.

Each of recirculation MUXes 212 and 222 is enabled by a respective enabling signal, i.e., the MUX select signal (“select” in FIG. 2). The enable signal of MUX 212 may be a READY signal asserted by a source finite state machine (FSM) 230, while the enable signal of MUX 222 may be a LOAD signal asserted by a destination FSM 240. FSMs 230 and 240 synchronize data transfers between clock domain 210 and clock domain 220.

Specifically, FSMs 230 and 240 facilitate the handshake process by generating a request (REQ) signal 270 and an acknowledge (ACK) signal 275. Each FSM includes one or more enabled registers. For example, a FSM may be constructed of a plurality of flip-flops coupled in sequence, where an output of a first flip-flop is coupled to an input of the next flip-flop in the chain. FSMs 230 and 240 are respectively connected to combinatorial logic 250 and 260. Through the combinatorial logic each FSM receives its enabling inputs. These enabling inputs may be the ACK and REQ signals (depending on which of the clock domains the FSM is connected to), reset signals, constant signals, and quasi-static signals. Through the enable outputs the READY and LOAD signals are sent to MUXes 212 and 222. Each of combinatorial logic 250 and 260 includes logical gates such as AND, OR, NAND, NOR, NOT, XOR, multiplexer, and demultiplexer, to name a few, but specifically excludes memory components such as memory cells, flip-flops, and the like.

As depicted in circuit 200, the data transfer over the “Data Cross” bus is synchronized by utilizing a handshake mechanism. An IC design that includes circuit 200, i.e., a clock-domain crossing with a handshake mechanism, is considered as a correct design. However, prior art solutions would classify circuit 200 as an unstable (or desynchronized) clock-domain crossing.

The presently-discussed embodiment according to the invention recognizes handshake data exchange at clock-domain crossings by performing a particular structural analysis of the circuitry as will be described in more detail below. It should be noted that, although the operations according to an exemplary embodiment of the invention is discussed for a small circuit, this is simply for the sake of providing a clear and easy-to-understand explanation. Specifically, the disclosed technique is operative in ICs having a large number of logic gates and a large number of clock domains.

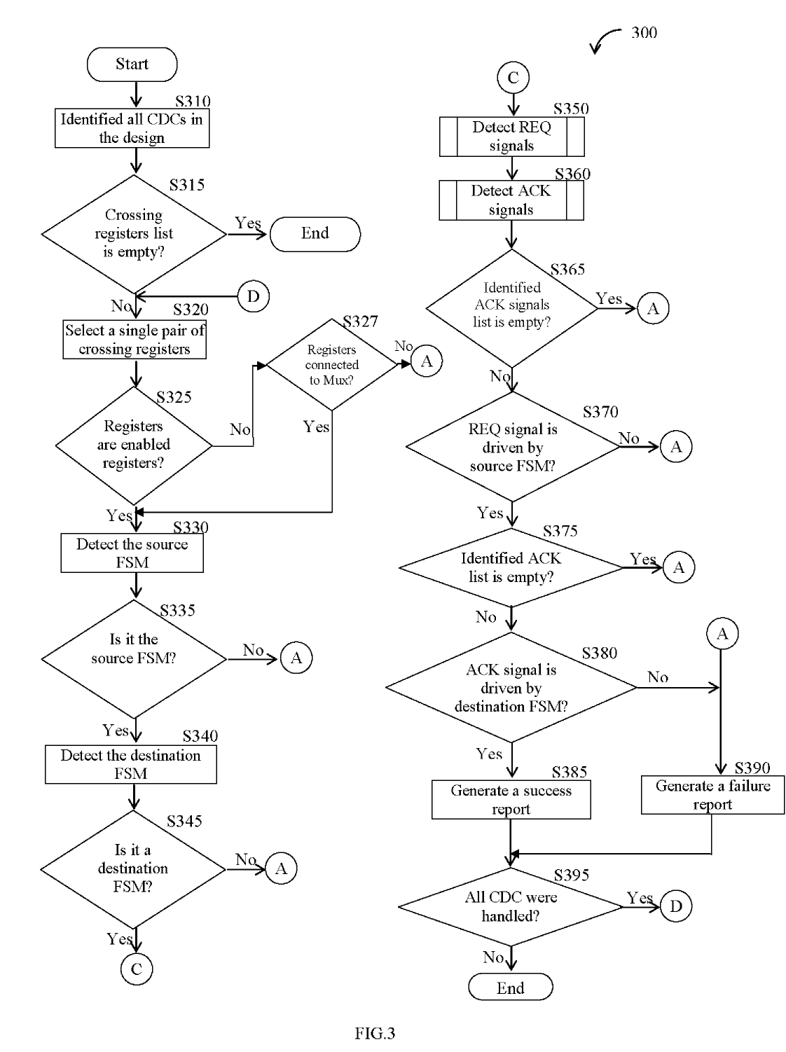

Referring to FIG. 3, an exemplary and non-limiting flowchart 300 describing the method for recognition of a handshake process at a clock-domain crossing of an IC design, in accordance with the present invention, is shown. At step S310, all clock-domain crossings encountered in a given IC design are identified. That is, pairs of crossing registers connected through a combinational path, which are clocked by different clocks, are searched for. All pairs of crossing registers are saved in a temporary list (hereinafter, the “crossing registers list”).

The clock-domain crossings in a design may be identified by any clock synchronization analysis tools known in the art. An example for such a tool is disclosed in U.S. patent application entitled “Method for Clock Synchronization Validation in Integrated Circuit Design”, Ser. No. 10/695,803, assigned in common to the same assignee as the present application, and is hereby incorporated for all that it contains, and especially its description relating to the identification of clock-domain crossings in paragraphs [19] through [27].

Furthermore, the crossing registers of a clock-domain crossing may be detected in a synthesized netlist produced by an IC synthesis tool. Synthesis tools produce gate level netlists based, for example, on the register transfer level (RTL) representation. Netlists generally include logical gates such as AND, NAND, NOR, OR, XOR, NXOR, NOT, and the like. One such synthesis tool is disclosed in a U.S. patent application entitled “An Apparatus and Method for Handling of Multi-Level Circuit Design Data”, Ser. No. 10/118,242, assigned to common assignee and is hereby incorporated for all that it contains, and especially its description relating to a synthesis tool in paragraphs [37] through [45].

At step S315, it is determined if the crossing registers list is empty, and if so execution ends; otherwise, execution continues with step S320.

At step S320, a single pair of crossing registers is selected from the crossing registers list, namely a clock-domain crossing to be analyzed is selected and the source register (e.g., register 214) as well as the destination register (e.g., register 224) are determined.

At step S325, it is checked whether both the source and destination registers are enabled registers. An enabled register is a register triggered by an “enabling signal”. Other types of enabled registers may be, but are not limited to, a register connected to a recirculation MUX (as shown in FIG. 2) or a register with a gated clock. The enabling signal of the former type is the MUX select signal and, for the latter type, is the signal gating the clock.

If the check made at step S325 results in an affirmative answer, execution continues with step S330; otherwise, execution proceeds to step S327 where it is checked if the both the source and destination registers have controlled synchronized MUXes in their data path. If so, execution continues with step S330; otherwise, execution processed to step S390 where a failure report is generated.

At step S330, from the enabling signal (e.g., the select MUX signal) of the source register (e.g., register 214), the design is traced back through the combinatorial logic (e.g., logic 250) until at least one register is encountered. At step S335, it is determined if the encountered register is an enabled register (or a register connected to a multiplexer in its data path). If so, this register is part of the source FSM (e.g., FSM 230) and execution continues with step S340; otherwise, the detected register is not part of a handshake mechanism and execution proceeds to step S390. At steps S340 and S345, an attempt is made to detect the destination FSM (e.g., FSM 240) in the same fashion described for steps S330 and S335. If this attempt succeeds, execution continues with step S350 where a procedure for detecting REQ signals is applied; otherwise, execution continues with step S390.

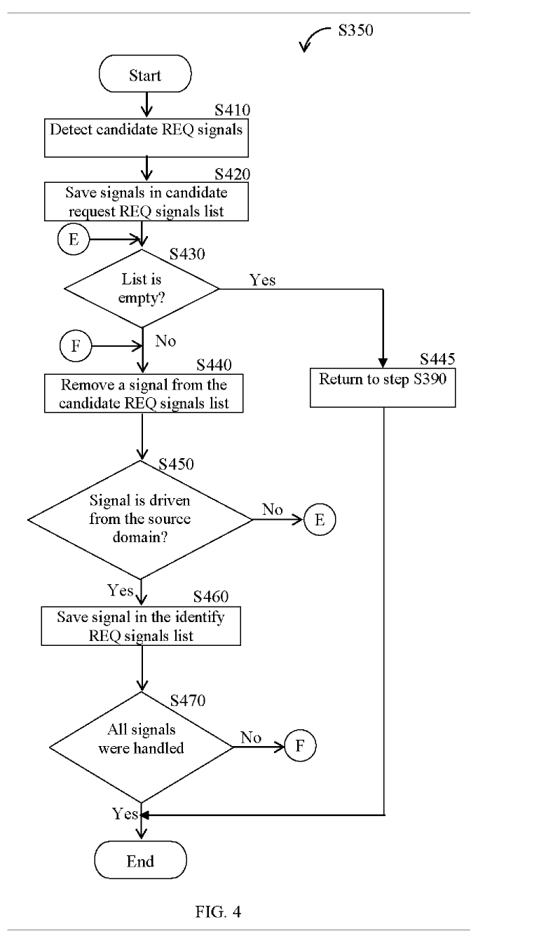

Refer now to FIG. 4, where an exemplary and non-limiting detailed flowchart for step S350 describes a procedure for detecting REQ signals. At step S410, candidate REQ signals are detected by tracing back from the enable inputs of the destination FSM through the combinatorial logic. The procedure ignores: enable inputs that end up back in the destination FSM, reset signals, constant signals, or quasi-static signals.

At step S420, all remaining enable inputs that are synchronized to the destination clock domain are saved in a temporary list (hereinafter, the “candidate REQ signals list”).

At step S430, it is determined whether the candidate REQ signals list is an empty list and, if so, at step S455, execution returns to step S390; otherwise execution proceeds to step S440, where each signal in the candidate REQ signals list is examined.

Specifically, at step S440 a given signal is removed from the list for analysis. At step S450 it is determined whether the signal is driven from the source clock-domain through a recognized synchronizer or an enabled register. The recognized synchronizer interfaces between the clock domains and may be, but is not limited to, a synchronization cell (e.g., a double-level register or a recirculation MUX double-registered control), a multi flip-flop synchronizer, and the like. If so, the selected signal is inserted, at step S460, to a temporary list (hereinafter, the “identified REQ signals list”); otherwise, the selected signal is not part of the handshake process and execution returns to step S430 without adding the signal to the identified REQ signals list.

At step S470 it is determined whether all signals in the candidate REQ signals list were handled and, if so, execution ends in FIG. 4 and processing goes on to step S360 in FIG. 3. Otherwise, execution returns to step S440 where another signal from the candidate REQ signals list to be tested is selected.

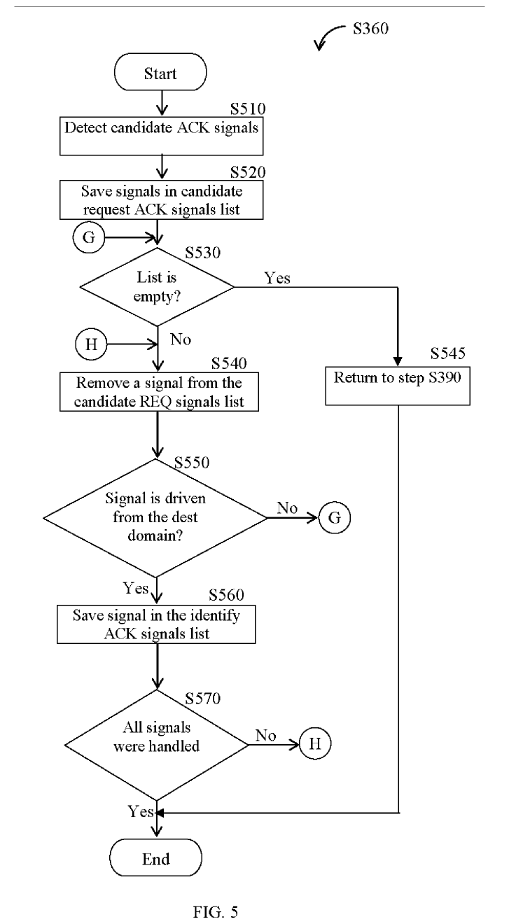

Referring back to FIG. 3, at step S360, a procedure for detecting ACK signals is executed as described in more detail with reference to FIG. 5. At step S510, all candidate ACK signals are detected by tracing back from the enable inputs of the source FSM through the combinatorial logic. The procedure ignores: enable inputs that end up back in the source FSM, reset signals, constant signals, or quasi-static signals.

At step S520, all remaining enable inputs, that are synchronized to the source clock domain, are saved in a temporary list (hereinafter, the “candidate ACK signals list”). At step S530, it is checked whether the candidate ACK signals list is empty, and if so, at step S545, execution returns to step S390; otherwise execution continues with step S540 where each signal in the candidate ACK signals list is examined. Specifically, at step S540, a signal is removed for analysis from the list and at step S550 it is determined whether the signal is driven from the destination clock-domain through a recognized synchronizer or an enabled register. The recognized synchronizer interfaces between clock domains and may be, but is not limited to, synchronization cell (e.g. a double-level register or a recirculation MUX double-registered control), a multi flip-flop synchronizer, and the like. If so, the selected signal is saved, at step S560, in a temporary list (hereinafter, the “identified ACK signals list”); otherwise, the signal is not part of the handshake process and execution returns to step S530. At step S570 it is determined whether all signals in the candidate ACK signals list were handled, and if so execution ends and returns to FIG. 3 just after step S360. Otherwise, execution returns to step S540 where another signal to be tested is selected.

Referring back to FIG. 3, at step S365, it is checked if the identified REQ signals list is empty, and if so execution continues with step S390; otherwise, when the list is not empty, processing continues with step S370.

At step S370, a selected signal is removed from the identified REQ signals list and the method checks if that signal is driven by: (1) the source FSM, and (2) at least one of the signals found in the identified ACK signals list. This is performed by tracing back from the destination FSM (e.g., FSM 240) through the combinatorial logic (e.g., logic 260) until encountering an enabled register (or registers) detected as the source FSM. If step S370 yields an affirmative answer, execution proceeds to step S375; otherwise, execution continues to step S390.

At step S375, it is checked whether the identified ACK signals list is empty and, if so, execution continues with step S390; otherwise, continuing with step S380, a selected signal is removed for analysis from the identified ACK signals list and the method checks whether that signal is driven by: (1) the destination FSM, and (2) at least one of the signals found in the identified REQ signals list. This is performed by tracing back from source FSM (e.g., FSM 230) through the combinatorial logic (e.g., logic 250) until encountering an enabled register (or registers) detected as the destination FSM.

If step S380 yields an affirmative answer, execution proceeds to step S385, where a success report is provided to the user; otherwise, execution continues with step S390. The success report indicates that a handshake process is recognized in the tested clock-domain crossing. This report may include the names of components and the signals participating in the process, as well as other information.

At step S390, a failure report indicting that a handshake process is not recognized in the currently tested clock-domain crossing is provided to the user. At step S395, a last check is made to determine if all clock-domain crossings were handled and if so execution ends; otherwise, execution returns to step S320 where a new pair of crossing registers is selected.

The method disclosed herein can be further embodied by a person skilled in the art as part of a computer software program, a computer aided design (CAD) system, a CAD program, and the like. One familiar with this field will appreciate such a computer program may be concretely provided in a computer readable medium of any kind, and that such a computer readable medium may have on it computer instructions to enable the computer to carry out various steps in a method as described above. It will also be understood by one familiar with this field that the computer will carry out such steps by way of a computer processor of any kind controlling a computer memory of any kind so that the computer instructions can be executed. Since such a computer system is very familiar and well understood, the illustration thereof has been omitted.

The present invention can be further utilized to verify the correctness of the handshake process recognized in an IC design using the method described in greater detail above. In one embodiment (not shown in a flowchart but now described), the verification method receives the list of signals participating in the handshake process and checks that each signal is asserted as a consequence of the reception of an enabling signal. That is to say that the verification method checks if: (1) a REQ signal is asserted only after data is available in the source register, (2) an ACK signal is asserted only after data is loaded to the destination register, and (3) a READY signal is not asserted before receiving an ACK signal.

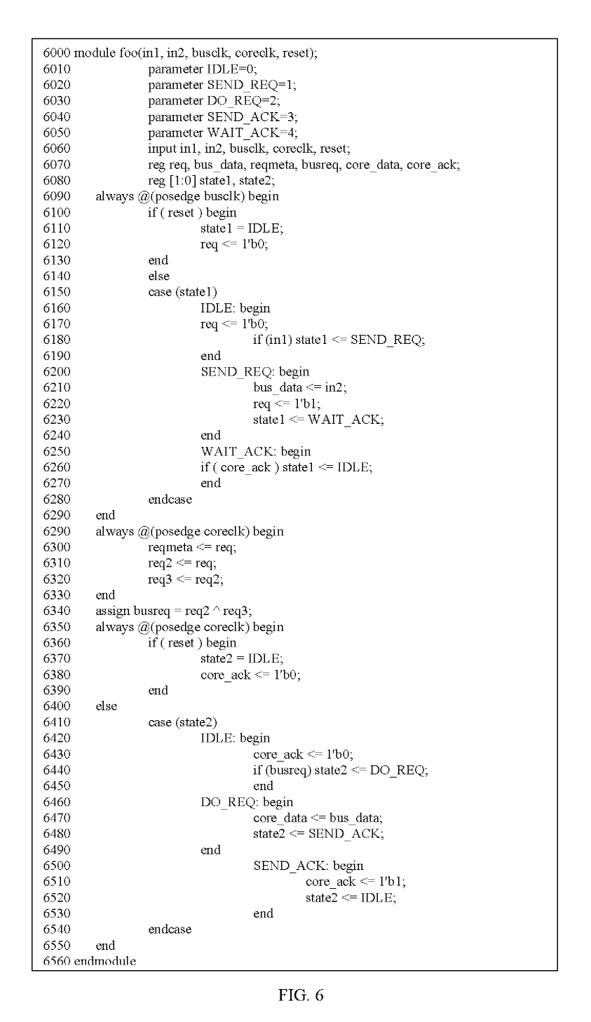

In another embodiment the present invention recognizes and verifies a handshake process from a RTL description of the IC design. An example for a RTL description of a module implementing the handshake process is provided in FIG. 6. In this embodiment, the verification method checks the correctness of state statements, i.e., the sequence of operations executed by the FSMs.

For example, as depicted in lines 6150-6280 and 6410-6540, the “state 1” refers to the source FSM while “state 2” refers to the destination FSM. The method verifies that “state 1” is changed to SEND_REQ only if the data is available in the input of a source register “in1” and once a REQ is asserted the state of “state 1” changes to “WAIT_ACK”. For “state 2” the method verifies that “state 2” is switched to SEND_ACK only if a REQ signal “busreq” is received and data is loaded to “core_bus”.

In one embodiment, the present invention is operative in conjunction with standard clock domain (or clock synchronization) analysis tools to eliminate the false violations reported by such tools. In this embodiment, there may be received a list of clock crossing-domains reported as unstable, and for each such clock-domain crossing domain the embodiment provides for the execution of recognizing and optionally verifying the correctness of a handshake data exchange as already described by the detailed examples mentioned above. This would relieve designers from the need to verify separately each and every clock-domain domain reported by the standard tools as being unstable.

Many variations to the above-identified embodiments are possible without departing from the scope and spirit of the invention. Possible variations have been presented throughout the foregoing discussion, and it will be appreciated that combinations and sub-combinations of the various embodiments described above will occur to those familiar with this field.

What is claimed is:

1. A method for the automatic recognizing of a handshake data exchange at a clock-domain crossing, comprising:
determining one or more clock-domain crossings in an integrated circuit (IC) design;
for each enabled source register and enabled destination register in each of the determined clock-domain crossings, recognizing a handshake data exchange by:
detecting a source final state machine (FSM) connected to the source enabled register;
detecting a destination FSM connected to the destination enabled register;
detecting at least one request signal driven by the source FSM; and
detecting at least one acknowledge signal driven by the destination FSM.

2. The method of claim 1, further comprising generating a report indicating that said handshake data exchange is identified in the IC design.

3. The method of claim 1, wherein the clock-domain crossing includes registers connected to a combinational path, and each of the registers is clocked by a different respective clock signal.

4. The method of claim 1, wherein said enabled register comprises at least one of: a register triggered by an enabling signal, a register connected to a recirculation multiplexer, a register with a gated clock, and a register connected through a data path to a multiplexer.

5. The method of claim 4, wherein the register comprises at least one of: a logic flip-flop, a memory cell, and combinational logic loops defining a de-facto memory.

6. The method of claim 3, wherein the combinational path comprises at least one of: a logical AND function, a logical OR function, a logical NAND function, a logical NOR function, a logical NOT function, a logical XOR function, and a multiplexer.

7. The method of claim 3, wherein the step of detecting a source FSM further comprises:
tracing back from the source enabled register through the combinational path until encountering a register; and
determining if the encountered register is an enabled register.

8. The method of claim 3, wherein the step of detecting a source FSM further comprises:
tracing back from the destination enabled register through the combinational path until encountering a register; and
checking if the encountered register is an enabled register.

9. The method of claim 1, wherein the step of detecting the request signal comprises:
determining, for each enable input of the destination FSM, whether the enable input is synchronized to a destination domain of the clock-domain crossing;
determining, for each enable input synchronized to the destination domain, whether the enable input is driven from a source domain through at least a recognized synchronizer; and
determining, for each enable input driven from the source domain, whether the enable input is generated by the source FSM using the at least one acknowledge signal.

10. The method of claim 1, wherein the step of detecting the acknowledge signal comprises:
determining, for each enable input of the source FSM, whether the enable input is synchronized to a source domain of the clock-domain crossing;
determining, for each enable input synchronized to the source domain, whether the enable input is driven from a destination domain through at least a recognized synchronizer; and
determining, for each enable input driven from the destination domain, whether the enable input is generated by the destination FSM using the at least one request signal.

11. The method of claim 1, further comprising using a clock synchronization analysis tool to identify the clock-domain crossings.

12. The method of claim 1, embodied as at least one of: a computer aided design (CAD) system, a CAD program, and a clock synchronization analysis tool.

13. A computer program product, including a computer-readable medium with instructions to enable a computer to implement a process for the automatic recognizing of a handshake data exchange at a clock-domain crossing, the process comprising:
determining one or more clock-domain crossings in an integrated circuit (IC) design;
for each enabled source register and enabled destination register in each of the determined clock-domain crossings, recognizing a handshake data exchange by:
detecting a source final state machine (FSM) connected to the source enabled register;
detecting a destination FSM connected to the destination enabled register;
detecting at least one request signal driven by the source FSM; and
detecting at least one acknowledge signal driven by the destination FSM.

14. The computer program product of claim 13, further comprising generating a report indicating that said handshake data exchange is identified in the IC design.

15. The computer program product of claim 13, wherein the clock-domain crossing includes registers connected to a combinational path, and each of the registers is clocked by a different respective clock signal.

16. The computer program product of claim 13, wherein said enabled register comprises at least one of: a register triggered by an enabling signal, a register connected to a recirculation multiplexer, a register with a gated clock, and a register connected through a data path to a multiplexer.

17. The computer program product of claim 16, wherein the register comprises at least one of: a logic flip-flop, a memory cell, and combinational logic loops defining a de-facto memory.

18. The computer program product of claim 15, wherein the combinational path comprises at least one of: a logical AND function, a logical OR function, a logical NAND function, a logical NOR function, a logical NOT function, a logical XOR function, and a multiplexer.

19. The computer program product of claim 15, wherein the step of detecting a source FSM further comprises:
tracing back from the source enabled register through the combinational path until encountering a register; and
determining if the encountered register is an enabled register.

20. The computer program product of claim 15, wherein the step of detecting a source FSM further comprises:
tracing back from the destination enabled register through the combinational path until encountering a register; and
checking if the encountered register is an enabled register.

21. The computer program product of claim 13, wherein the step of detecting the request signal comprises:
determining, for each enable input of the destination FSM whether the enable input is synchronized to a destination domain of the clock-domain crossing;
determining, for each enable input synchronized to the destination domain, whether the enable input is driven from a source domain through at least a recognized synchronizer; and
determining, for each enable input driven from the source domain, whether the enable input is generated by the source FSM using the at least one acknowledge signal.

22. The computer program product of claim 13, wherein the step of detecting the acknowledge signal comprises:
determining, for each enable input of the source FSM, whether the enable input is synchronized to a source domain of the clock-domain crossing;
determining, for each enable input synchronized to the source domain, whether the enable input is driven from a destination domain through at least a recognized synchronizer; and
determining, for each enable input driven from the destination domain, whether the enable input is generated by the destination FSM using the at least one request signal.

23. The computer program product of claim 13, further comprising using a clock synchronization analysis tool to identify the clock-domain crossings.

24. The computer program product of claim 13, wherein the computer is at least one of: computer aided design (CAD) system, a CAD program, and a clock synchronization analysis tool.
